(19) United States
(12) Patent Application Publication
(10) Pub. No.: US 2011/0132867 A1
(43) Pub. Date: Jun. 9, 2011

(54) METHOD AND SYSTEM FOR IMPRINT LITHOGRAPHY

(75) Inventors: Henry Hung Yang, San Jose, CA (US); Kim Yang Lee, Fremont, CA (US); Yautzong Hsu, Fremont, CA (US); Shuaigang Xiao, Fremont, CA (US); Xiaomin Yang, Fremont, CA (US); HongYing Wang, Fremont, CA (US); Zhaoning Yu, Mountain View, CA (US)

(73) Assignee: SEAGATE TECHNOLOGY LLC, Scotts Valley, CA (US)

(21) Appl. No.: 12/915,583

(22) Filed: Oct. 29, 2010

Related U.S. Application Data
(60) Provisional application No. 61/283,823, filed on Dec. 9, 2009.

(51) Int. Cl. B29C 71/04; B29C 59/16

(52) U.S. Cl. 216/17; 264/293; 264/447; 425/174; 156/345.1

(57) ABSTRACT

A method and apparatus of imprint lithography wherein the method includes depositing a material on a patterned surface of a conductive substrate, and pressing a transparent substrate and the conductive substrate together, wherein the pressing causes the material to conform to the patterned surface. Energy is applied to the material to form patterned material from the material. The transparent substrate and the conductive substrate are separated, wherein the patterned material adheres to the transparent substrate.

### CROSS REFERENCE TO RELATED APPLICATION

The present application claims priority from U.S. Provisional Patent Application No. 61/283,823, which was filed on Dec. 9, 2009, and titled “Template Fabrication Using Silicon Wafer as Initial Template,” which provisional application is hereby incorporated by reference as though fully set forth herein.

### FIELD

Embodiments according to the present invention generally relate to imprint lithography.

### BACKGROUND

Micro-fabrication involves the fabrication of very small structures, for example structures having features on the order of micro-meters or smaller. Lithography is a micro-fabrication technique used to create ultra-fine (sub-25 nm) patterns in thin film on a substrate. During lithography, a mold having at least one protruding feature is pressed into the thin film. The protruding feature in the mold creates a recess in the thin film, thus creating an image of the mold. The thin film retains the image as the mold is removed. The mold may be used to imprint multiple thin films on different substrates.

### BRIEF DESCRIPTION OF THE DRAWINGS

The present invention is illustrated by way of example, and not by way of limitation, in the figures of the accompanying drawings.

FIG. 1 is a simplified cross-sectional view of an imprint fabrication system at an early stage of manufacture, according to an embodiment of the present invention.

FIG. 2 is a simplified cross-sectional view of the imprint fabrication system during imprinting of the resist layer, according to an embodiment of the present invention.

FIG. 3 is a simplified cross-sectional view of the imprint fabrication system during hardening of the resist layer, according to an embodiment of the present invention.

FIG. 4 is a simplified cross-sectional view of the imprint fabrication system during separation of the patterned resist layer from the substrate, according to an embodiment of the present invention.

FIG. 5 is a simplified cross-sectional view of the imprint fabrication system after etching of the patterned resist layer, according to an embodiment of the present invention.

FIG. 6 is a simplified cross-sectional view of the imprint fabrication system after etching of the transparent substrate, according to an embodiment of the present invention.

FIG. 7 is a simplified cross-sectional view of the imprint fabrication system after clean up of the etched surface of the transparent substrate, according to an embodiment of the present invention.

FIG. 8 depicts a flowchart of a process of imprint lithography, according to an embodiment of the present invention.

FIG. 9 depicts a flowchart of a process of imprint lithography, according to another embodiment of the present invention.

FIG. 10 is a data storage device in which embodiments of the present invention can be implemented to form bit-patterned media.

FIG. 11 is a simplified cross-sectional view of a perpendicular magnetic recording medium, which may be used for the data storage disc.

FIG. 12 is a simplified cross-sectional view of a portion of the perpendicular magnetic recording medium with a head unit.

### DETAILED DESCRIPTION

Reference will now be made in detail to embodiments, examples of which are illustrated in the accompanying drawings. While the embodiments will be described in conjunction with the drawings, it will be understood that they are not intended to limit the embodiments. On the contrary, the embodiments are intended to cover alternatives, modifications and equivalents. Furthermore, in the following detailed description, numerous specific details are set forth in order to provide a thorough understanding. However, it will be recognized by one of ordinary skill in the art that the embodiments may be practiced without these specific details. In other instances, well-known methods, procedures, components, and circuits have not been described in detail as not to unnecessarily obscure aspects of the embodiments.

For expository purposes, the term “horizontal” as used herein is defined as a plane parallel to the plane or surface of a substrate, regardless of its orientation. The term “vertical” refers to a direction perpendicular to the horizontal as just defined. Terms such as “above,” “below,” “bottom,” “top,” “side,” “higher,” “lower,” “upper,” “over,” and “under” are defined with respect to the horizontal plane.

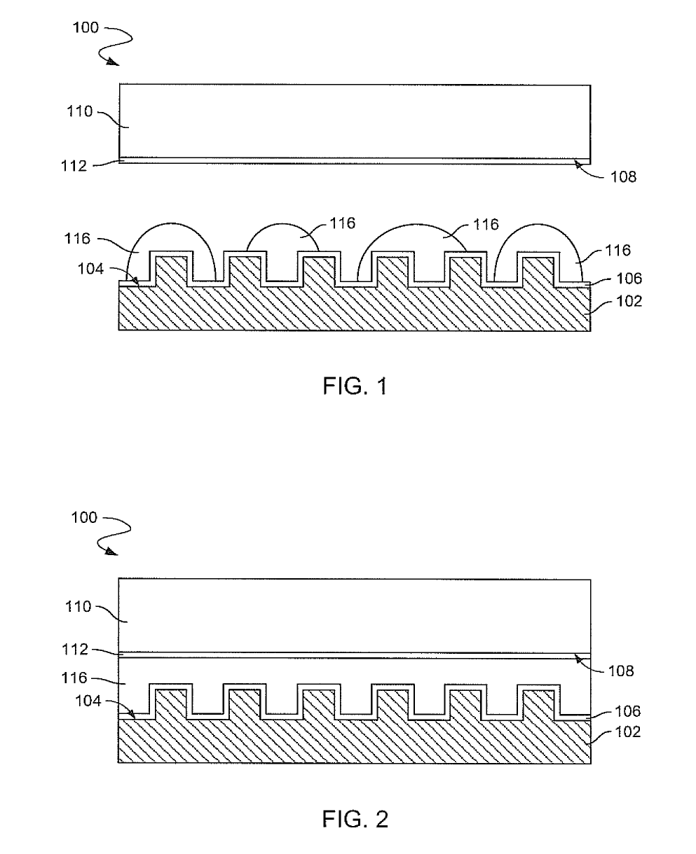

FIG. 1 is a simplified cross-sectional view of an imprint fabrication system 100 at an early stage of manufacture, according to an embodiment of the present invention. The imprint fabrication system 100 forms a pattern in a transparent substrate from a conductive substrate, e.g. thermally conductive, electron conductive, etc. For example, a high resolution pattern may be formed in a silicon substrate using e-beam lithography. The pattern in the silicon substrate is then transferred to the transparent substrate. In one embodiment, the transparent substrate is used as a template for imprint lithography.

In FIG. 1, a patterned surface 104 has been formed in a substrate 102. The patterned surface 104 may have been formed using a number of well known techniques, e.g. e-beam lithography, block copolymer self-assembly, etching, etc. For example, the substrate 102 may be etched using chlorine-containing gasses, e.g. CL₂ and HCL, bromine-containing gasses, e.g. HBr, or fluorine-containing gasses, e.g. CF₄, CHF₃, and SF₆.

In an embodiment, the substrate 102 is a conductive material, e.g. silicon. For example, during e-beam lithography, a conductive substrate helps to dissipate the electrons being transferred onto the substrate. However, a non-conductive substrate, e.g. fused silica, may not be able to dissipate the electrons. Therefore, an additional layer of conductive material may be added to the non-conductive substrate. In addition, the conductive substrate may also dissipate heat during processes that apply thermal energy.

In some embodiments, the patterned surface 104 may be coated with a release material 106. The release material 106 may be a release promoter, for example Relmat™, commercially available from Molecular Imprints, Inc., located in Austin, Tex. The release material 106 aids in the separation (see FIG. 4) of a resist layer 116 from the substrate 102, by helping the resist layer 116 to separate from the substrate 102. In an embodiment, the release material 106 may be non-metallic and/or non-conductive.

In various embodiments, the resist layer 116 may be an ultra violet resist layer. The resist layer 116 may be deposited on the patterned surface 104 or the release material 106, when present. In one embodiment, the release layer 116 may be deposited as drops or by spin coating.

A substantially transparent substrate 110, e.g. fused silica, overlies the resist layer 116 and is operable to be pressed together with the substrate 102. In an embodiment, the substantially transparent substrate 110 includes a substantially planar surface 108, facing the resist layer 116.

In some embodiments, the substantially transparent substrate 110 may be coated with an adhesive material 112. The adhesive material 112 may be an adhesion promoter, for example Valmat™, commercially available from Molecular Imprints, Inc., located in Austin, Tex. The adhesive material 112 aids in the separation (see FIG. 4) of the resist layer 116 from the substrate 102, by helping the resist layer 116 stick to the transparent substrate 110. In an embodiment, the adhesive material 112 may be non-metallic and/or non-conductive.

FIG. 2 is a simplified cross-sectional view of the imprint fabrication system 100 during imprinting of the resist layer 116, according to an embodiment of the present invention. The transparent substrate 110 and the substrate 102 are forcefully pressed together.

In an embodiment, during pressing, the transparent substrate 110 and the substrate 102 may be pressed into close proximity to one another without touching. In alternate embodiments, during pressing, the transparent substrate 110 and the substrate 102 may contact each other (not shown). Pressing together of the transparent substrate 110 and the substrate 102 causes the resist layer 116 to conform to the patterned surface 104.

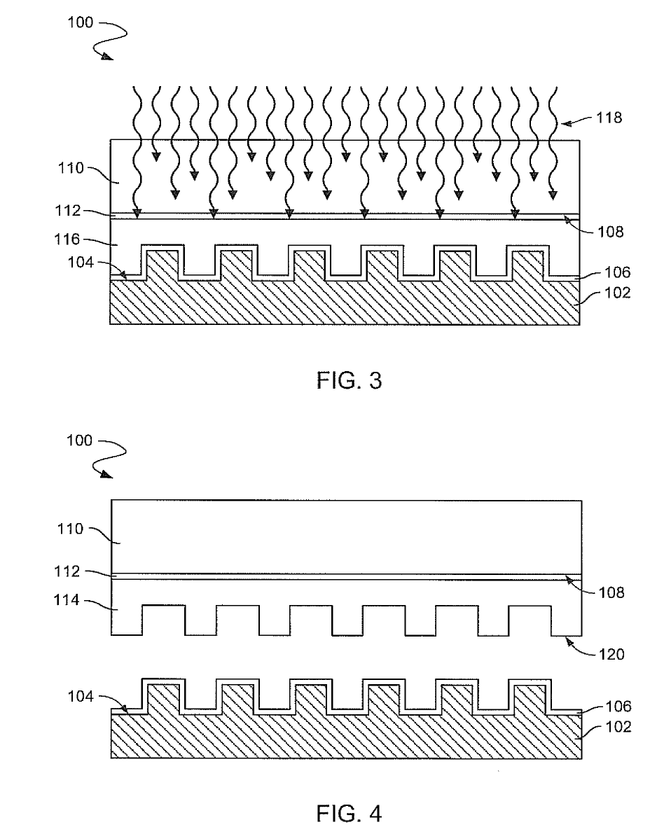

FIG. 3 is a simplified cross-sectional view of the imprint fabrication system 100 during hardening of the resist layer 116, according to an embodiment of the present invention. A light source (not shown) delivers energy 118 to the resist layer 116. For example, the energy 118 may be ultra violet light. The energy 118 passes through the transparent substrate 110 and the adhesive material 112. The resist layer 116 absorbs the energy 118, causing the resist layer 116 to harden and form a patterned resist layer 114 (see FIG. 4). In some embodiments, the energy 118 may be thermal energy.

FIG. 4 is a simplified cross-sectional view of the imprint fabrication system 100 during separation of the patterned resist layer 114 from the substrate 102, according to an embodiment of the present invention. The transparent substrate 110 and the substrate 102 are moved apart, causing the patterned resist layer 114 to separate from the substrate 102. In some embodiments, the release material 106 and the adhesive material 112 aid in the separation by helping the patterned resist layer 114 to stick to the transparent substrate 110 and therefore not stick to the substrate 102.

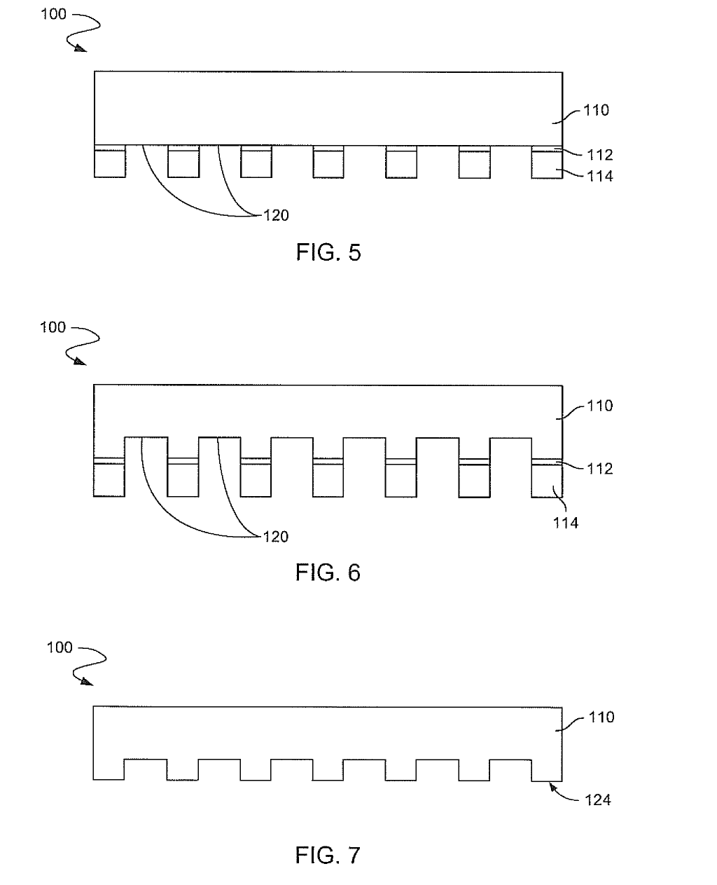

FIG. 5 is a simplified cross-sectional view of the imprint fabrication system 100 after etching of the patterned resist layer 114, according to an embodiment of the present invention. Portions of the patterned resist layer 114 and the adhesive material 112 may be etched to expose underlying surface regions 120 of the transparent substrate 110. For example, the patterned resist layer 114 may be etched in a de-scum process that may utilize an O₂ reactive ion etch process.

FIG. 6 is a simplified cross-sectional view of the imprint fabrication system 100 after etching of the transparent substrate 110, according to an embodiment of the present invention. The surface regions 120 may be etched to create features in the transparent substrate 110. For example, the transparent substrate 110 may be fused silica. The fused silica in the surface regions 120 may be etched utilizing fluorine containing gasses, e.g. CF₄, CHF₃, SF₆, etc.

FIG. 7 is a simplified cross-sectional view of the imprint fabrication system 100 after clean up of the etched surface of the transparent substrate 110, according to an embodiment of the present invention. Remaining patterned resist layer 114 (see FIG. 6) and adhesive material 112 (see FIG. 6) have been removed, for example using an O₂ reactive ion etch process. The transparent substrate 110 has a topographically patterned surface 124 that is a negative image of the patterned surface 104 (see FIG. 1). In some embodiments (not shown) the transparent substrate 110 has a topographically patterned surface 124 that is a positive image of the patterned surface 104 (see FIG. 1).

In an embodiment, the topographically patterned surface 124 of the transparent substrate 110 may be used as a template in further processing, e.g. imprinting. For example, the topographically patterned surface 124 of the transparent substrate 110 may be utilized for forming a servo-patterned magnetic or magneto-optical medium, a track-patterned magnetic medium, a bit patterned magnetic medium, a patterned read-only medium, a wobble-grooved patterned readable compact disk medium, a readable-writable compact disk medium, a digital video disk medium, etc.

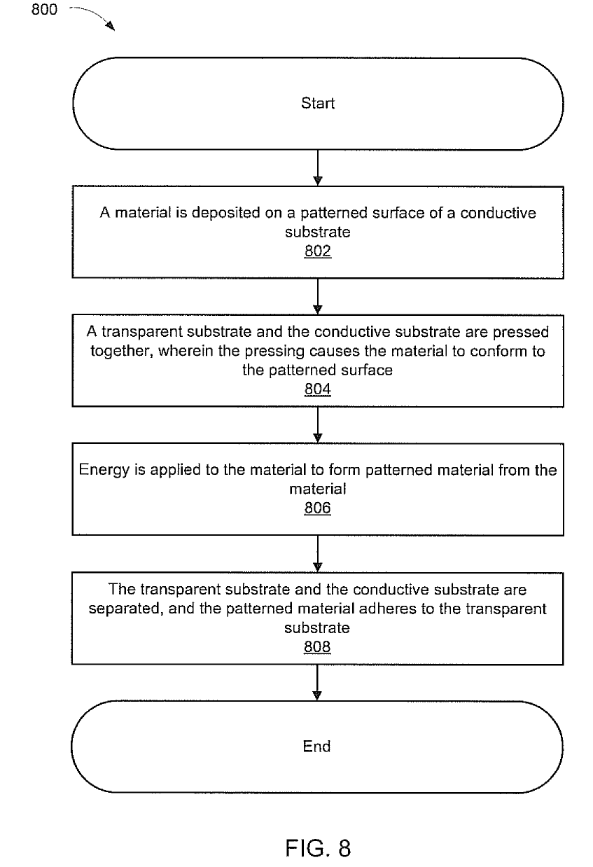

FIG. 8 depicts a flowchart 800 of a process of imprint lithography, according to an embodiment of the present invention. In block 802, a material is deposited on a patterned surface of a conductive substrate. In an embodiment the conductive substrate is a silicon substrate. For example, in FIG. 1 a resist layer is disposed between a conductive silicon substrate and a substantially transparent substrate. In an embodiment, the substantially transparent substrate is a fused silica substrate.

In block 804, a transparent substrate and the conductive substrate are pressed together, where pressing causes the material to conform to the patterned surface. In an embodiment the patterned surface includes a release material, and the transparent substrate includes an adhesion material. For example, in FIG. 2 the transparent substrate and the substrate are pressed together and the resist layer conforms to the patterned surface. Thus, in FIG. 2 the silicon substrate and the substantially transparent substrate are operable to be pressed together.

In a block 806 of FIG. 8, energy is applied to the material to form patterned material from the material. In an embodiment the energy is thermal energy or light energy. For example in FIG. 3, light is delivered from a light source and through the transparent substrate. The light energy is absorbed by the resist. In some embodiments the light energy is ultra violet light energy. Thus, in FIG. 3 the substantially transparent substrate is operable to allow energy to pass therethrough.

In a block 808 of FIG. 8, the transparent substrate and the conductive substrate are separated, and the patterned material adheres to the transparent substrate. For example, in FIG. 4 the transparent substrate and the substrate are moved apart, causing the patterned material of the resist layer to separate from the substrate. In various embodiments, the patterned material and the transparent substrate are etched to form a negative image of the patterned surface. In some embodiments, the patterned material and the transparent substrate are etched to form a positive image of the patterned surface.

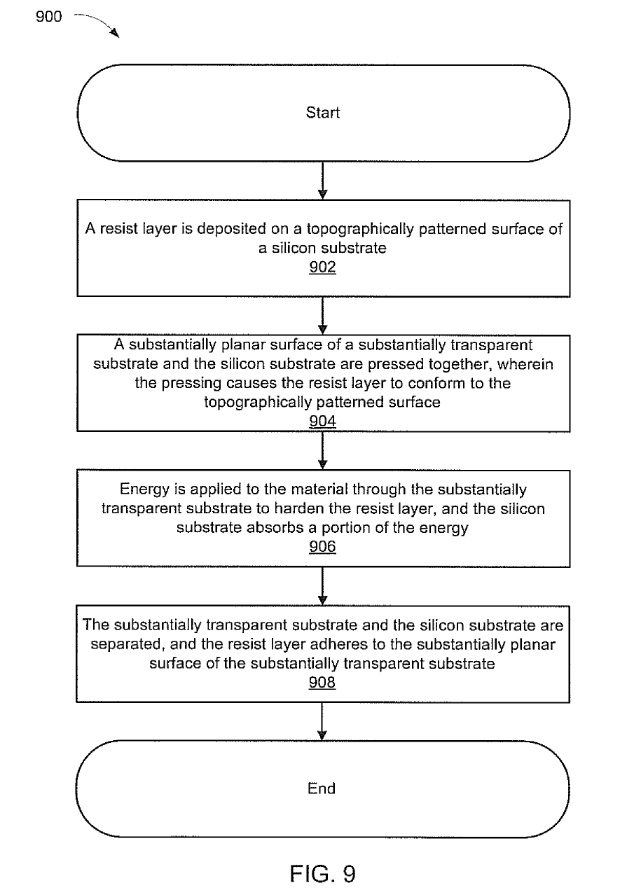

FIG. 9 depicts a flowchart 900 of a process of imprint lithography, according to another embodiment of the present invention. In block 902, a resist layer is deposited on a topographically patterned surface of a silicon substrate. For example, in FIG. 1 a resist layer is disposed between a conductive silicon substrate and a substantially transparent substrate. In an embodiment the substantially transparent substrate is a fused silica substrate. Thus, in FIG. 1 the resist layer is operable to adhere to the substantially transparent substrate.

In block 904, a substantially planar surface of a substantially transparent substrate and the silicon substrate are pressed together, where pressing causes the resist layer to conform to the topographically patterned surface. In an embodiment, the topographically patterned surface includes a non-adhesive material, and the substantially transparent substrate includes an adhesive material. For example, in FIG. 2 the substantially transparent substrate and the substrate are pressed together and the resist layer conforms to the topographically patterned surface.

In a block 906 of FIG. 9, energy is applied to the material through the substantially transparent substrate to harden the resist layer, and the silicon substrate absorbs a portion of the energy. In an embodiment the energy is thermal energy or ultra violet light energy. For example in FIG. 3, light is delivered from a light source and through the transparent substrate. The light energy is absorbed by the resist.

In a block 908, the substantially transparent substrate and the silicon substrate are separated, and the resist layer adheres to the substantially planar surface of the substantially transparent substrate. For example, in FIG. 4 the transparent substrate and the substrate are moved apart, causing the patterned material of the resist layer to separate from the substrate.

In various embodiments, the resist layer and a portion of the substantially transparent substrate are removed to from a patterned surface in the substantially transparent substrate. For example, in FIGS. 5, 6, and 7 the resist layer, the adhesive material, and portions of the substantially transparent substrate are removed to form a pattern in the substantially transparent substrate. Thus, the substantially transparent substrate is operable to be etched to from a negative image of the topographically patterned surface. In some embodiments the substantially transparent substrate is operable to be etched to form a positive image of the topographically patterned surface.

Magnetic storage media are widely used in various applications, particularly in the computer industry for data storage and retrieval applications, as well as for storage of audio and video signals. Perpendicular magnetic recording media, for example hard disc drive storage devices, include recording media with a perpendicular anisotropy in the magnetic layer. In perpendicular magnetic recording media, residual magnetization is formed in a direction perpendicular to the surface of the magnetic medium, typically by a layer of a magnetic material on a substrate.

A perpendicular recording disc drive head typically includes a trailing write pole, and a leading return or opposing pole magnetically coupled to the write pole. In addition, an electrically conductive magnetizing coil surrounds the yoke of the write pole. During operation, the recording head flies above the magnetic recording medium by a distance referred to as the fly height. To write to the magnetic recording medium, the magnetic recording medium is moved past the recording head so that the recording head follows the tracks of the magnetic recording medium, with the magnetic recording medium first passing under the return pole and then passing under the write pole. Current is passed through the coil to create magnetic flux within the write pole. The magnetic flux passes from the write pole tip, through the hard magnetic recording track, into the soft underlayer, and across to the return pole. In addition to providing a return path for the magnetic flux, the soft underlayer produces magnetic charge images of the magnetic recording layer, increasing the magnetic flux and increasing the playback signal. The current can be reversed, thereby reversing the magnetic field and reorienting the magnetic dipoles.

The perpendicular recording medium is a continuous layer of discrete, contiguous magnetic crystals or domains. Within the continuous magnetic layer, discrete information is stored in individual bits. The individual bits are magnetically oriented positively or negatively, to store binary information. The number of individual bits on the recording medium is a function of the areal density. As areal densities increase, the amount of information stored on the recording medium also increases. Manufacturers strive to satisfy the ever-increasing consumer demand for higher capacity hard drives by increasing the areal density.

High density perpendicular recording media use carefully balanced magnetic properties. These carefully balanced magnetic properties include sufficiently high anisotropy (perpendicular magnetic orientation) to ensure thermal stability, resist erasure, and function effectively with modern disc drive head designs; and grain-to-grain uniformity of magnetic properties sufficient to maintain thermal stability and minimum switching field distribution (SFD).

As recording densities increase, smaller grain structures help to maintain the number of magnetic particles in a bit at a similar value. Smaller grain structures are easier to erase, requiring higher anisotropy to maintain thermal stability, and making writability worse. Further, when individual storage bits within magnetic layers of magnetic recording media are reduced in size, they store less energy making it easier for the bits to lose information. Also, as individual weaker bits are placed closer together, it is easier for continuous read/write processes and operating environments to create interference within and between the bits. This interference disrupts the read/write operations, resulting in data loss.

The magnetic layers are designed as an ordered array of uniform islands, each island storing an individual bit. This is referred to as bit patterned media. By eliminating the continuous magnetic layer and restricting the bits to discrete magnetic islands, interference is reduced and areal densities are increased. However, high areal density bit patterned media (e.g., >500 Gbpsi) demands high anisotropy of the magnetic material in the islands.

Methods and media structures are described herein, which embodiments of the present invention as described above, may optimize anisotropy for bit patterned magnetic recording media. It is appreciated that magnetic recording media as discussed herein may be utilized with a variety of systems including disc drive memory systems, etc.

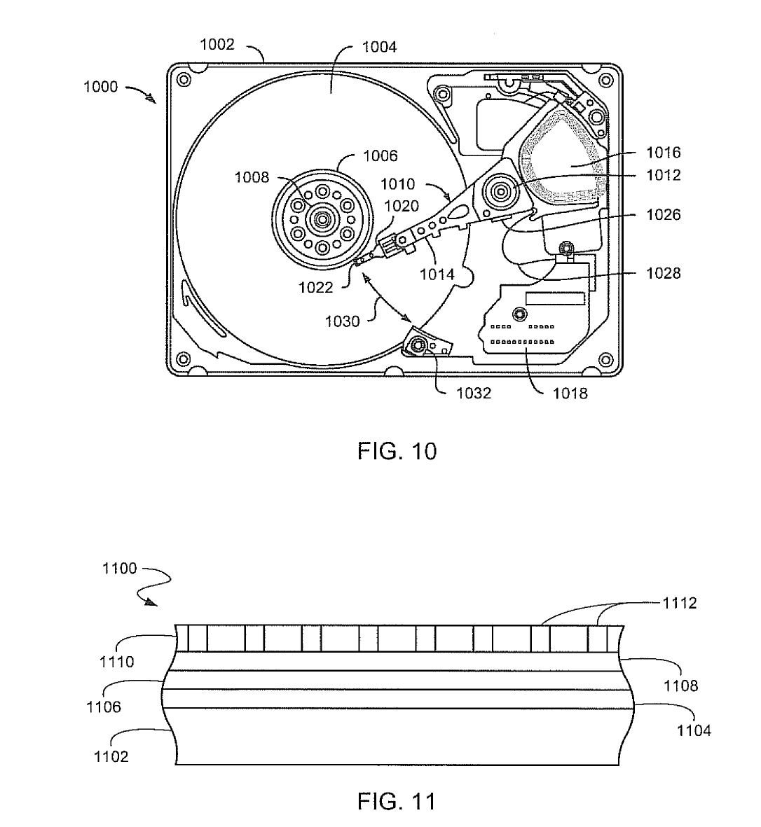

FIG. 10 is a data storage device in which embodiments of the present invention can be implemented to form bit-patterned media. FIG. 10 is a plan view of a disc drive 1000. The disc drive 1000 generally includes a base plate 1002 and a cover (not shown) that may be disposed on the base plate 1002 to define an enclosed housing for various disc drive components. The disc drive 1000 includes one or more data storage discs 1004 of computer-readable data storage media. Typically, both of the major surfaces of each data storage disc 1004 include a plurality of concentrically disposed tracks for data storage purposes. Each data storage disc 1004 is mounted on a hub or spindle 1006, which in turn is rotatably interconnected with the base plate 1002 and/or cover. Multiple data storage discs 1004 are typically mounted in vertically spaced and parallel relation on the spindle 1006. A spindle motor 1008 rotates the data storage discs 1004 at an appropriate rate.

The disc drive 1000 also includes an actuator arm assembly 1010 that pivots about a pivot bearing 1012, which in turn is rotatably supported by the base plate 1002 and/or cover. The actuator arm assembly 1010 includes one or more individual rigid actuator arms 1014 that extend out from near the pivot bearing 1012. Multiple actuator arms 1014 are typically disposed in vertically spaced relation, with one actuator arm 1014 being provided for each major data storage surface of each data storage disc 1004 of the disc drive 1000. Other types of actuator arm assembly configurations could be utilized as well, such as an “E” block having one or more rigid actuator arm tips or the like that cantilever from a common structure. Movement of the actuator arm assembly 1010 is provided by an actuator arm drive assembly, such as a voice coil motor 1016 or the like. The voice coil motor 1016 is a magnetic assembly that controls the operation of the actuator arm assembly 1010 under the direction of control electronics 1018.

A load beam or suspension 1020 is attached to the free end of each actuator arm 1014 and cantilevers therefrom. Typically, the suspension 1020 is biased generally toward its corresponding data storage disc 1004 by a spring-like force. A slider 1022 is disposed at or near the free end of each suspension 1020. What is commonly referred to as the read/write head (e.g., transducer) is appropriately mounted as a head unit (not shown) under the slider 1022 and is used in disc drive read/write operations. The head unit under the slider 1022 may utilize various types of read sensor technologies such as anisotropic magnetoresistive (AMR), giant magnetoresistive (GMR), tunneling magnetoresistive (TuMR), other magnetoresistive technologies, or other suitable technologies.

The head unit under the slider 1022 is connected to a preamplifier 1026, which is interconnected with the control electronics 1018 of the disc drive 1000 by a flex cable 1028 that is typically mounted on the actuator arm assembly 1010. Signals are exchanged between the head unit and its corresponding data storage disc 1004 for disc drive read/write operations. In this regard, the voice coil motor 1016 is utilized to pivot the actuator arm assembly 1010 to simultaneously move the slider 1022 along a path 1030 and across the corresponding data storage disc 1004 to position the head unit at the appropriate position on the data storage disc 1004 for disc drive read/write operations.

When the disc drive 1000 is not in operation, the actuator arm assembly 1010 is pivoted to a “parked position” to dispose each slider 1022 generally at or beyond a perimeter of its corresponding data storage disc 1004, but in any case in vertically spaced relation to its corresponding data storage disc 1004. In this regard, the disc drive 1000 includes a ramp assembly 1032 that is disposed beyond a perimeter of the data storage disc 1004 to both move the corresponding slider 1022 vertically away from its corresponding data storage disc 1004 and to also exert somewhat of a retaining force on the actuator arm assembly 1010.

FIG. 11 is a simplified cross-sectional view of a perpendicular magnetic recording medium 1100, which may be used for the data storage disc 1004 (FIG. 10). The perpendicular magnetic recording medium 1100 is an apparatus including multiple layers established upon a substrate 1102. A seed layer 1108 is a layer that is established overlying the substrate. A base layer 1110 is a layer that is established overlying the seed layer 1108. Perpendicular magnetic recording islands 1112 are recording areas that are established in the base layer 1110 and on the seed layer 1108.

The substrate 1102 can be fabricated from materials known to those skilled in the art to be useful for magnetic recording media for hard disc storage devices. For example, the substrate 1102 may be fabricated from aluminum (Al) coated with a layer of nickel phosphorous (NiP). However, it will be appreciated that the substrate 1102 can also be fabricated from other materials such as glass and glass-containing materials, including glass-ceramics. The substrate 1102 may have a smooth surface upon which the remaining layers can be deposited.

In a further embodiment, a buffer layer 1104 is established overlying the substrate 1102, a soft underlayer 1106 is established overlying the buffer layer 1104, and the seed layer 1108 is overlying the soft underlayer 1106. The buffer layer 1104 can be established from elements such as Tantalum (Ta). The soft underlayer 1106 can be established from soft magnetic materials such as CoZrNb, CoZrTa, FeCoB and FeTaC. The soft underlayer 1106 can be formed with a high permeability and a low coercivity. For example, in an embodiment the soft underlayer 1106 has a coercivity of not greater than about 10 oersteds (Oe) and a magnetic permeability of at least about 50. The soft underlayer 1106 may comprise a single soft underlayer or multiple soft underlayers, and may be separated by spacers. If multiple soft underlayers are present, the soft underlayers can be fabricated from the same soft magnetic material or from different soft magnetic materials.

In the embodiment illustrated, the seed layer 1108 is disposed on the soft underlayer 1106. The seed layer 1108 can be established, for example, by physical vapor deposition (PVD) or chemical vapor deposition (CVD) from noble metal materials such as, for example, Ru, Ir, Pd, Pt, Os, Rh, Au, Ag or other alloys. The use of these materials results in desired growth properties of the perpendicular magnetic recording islands 1112.

The perpendicular magnetic recording islands 1112 as described herein may be formed within the base layer 1110 and on the seed layer 1108 utilizing embodiments of the present invention. For example, the topographically patterned surface 124 (see FIG. 7) of the transparent substrate 110 (see FIG. 7) may be used during formation of the perpendicular magnetic recording islands 1112. The perpendicular magnetic recording islands 1112 can be established to have an easy magnetization axis (e.g., the C-axis) that is oriented perpendicular to the surface of the perpendicular magnetic recording medium 1100. Useful materials for the perpendicular magnetic recording islands 1112 include cobalt-based alloys with a hexagonal close packed (hcp) structure. Cobalt can be alloyed with elements such as chromium (Cr), platinum (Pt), boron (B), niobium (Nb), tungsten (W) and tantalum (Ta).

The perpendicular magnetic recording medium 1100 can also include a protective layer (not shown) on top of the perpendicular magnetic recording islands 1112 and/or the base layer 1110, such as a protective carbon layer, and a lubricant layer disposed over the protective layer. These layers are adapted to reduce damage from the read/write head interactions with the recording medium during start/stop operations.

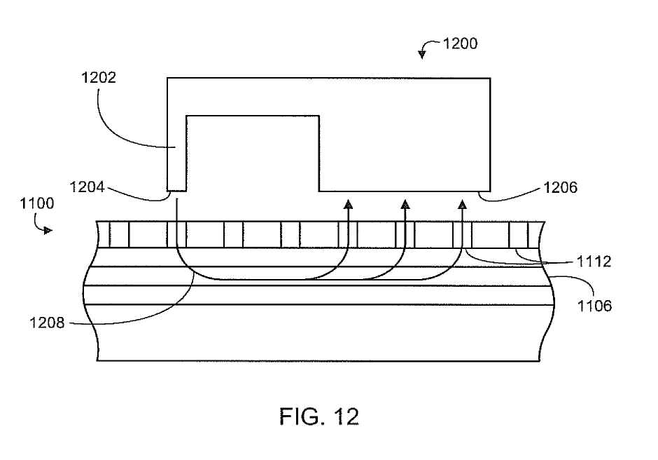

FIG. 12 is a simplified cross-sectional view of a portion of the perpendicular magnetic recording medium 1100 with a head unit 1200. During the writing process, a perpendicular write head 1202 flies or floats above the perpendicular magnetic recording medium 1100. The perpendicular write head 1202 includes a write pole 1204 coupled to an auxiliary pole 1206. The arrows shown indicate the path of a magnetic flux 1208, which emanates from the write pole 1204 of the perpendicular write head 1202, entering and passing through at least one perpendicular magnetic recording island 1112 in the region below the write pole 1204, and entering and traveling within the soft underlayer 1106 for a distance. The magnetically soft underlayer 1106 serves to guide magnetic flux emanating from the head unit 1200 through the recording island 1112, and enhances writability. As the magnetic flux 1208 travels towards and returns to the auxiliary pole 1206, the magnetic flux 1208 disperses.

The magnetic flux 1208 is concentrated at the write pole 1204, and causes the perpendicular magnetic recording island 1112 under the write pole 1204 to magnetically align according to the input from the write pole 1204. As the magnetic flux 1208 returns to the auxiliary pole 1206 and disperses, the magnetic flux 1208 may again encounter one or more perpendicular magnetic recording islands 1112. However, the magnetic flux 1208 is no longer concentrated and passes through the perpendicular magnetic recording islands 1112, without detrimentally affecting the magnetic alignment of the perpendicular magnetic recording islands 1112.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

What is claimed is:

1. A method comprising:
depositing a material on a patterned surface of a conductive substrate;
pressing a transparent substrate and said conductive substrate together, wherein said pressing causes said material to conform to said patterned surface;
applying energy to said material through the transparent substrate to form patterned material from said material; and
separating said transparent substrate and said conductive substrate, wherein said patterned material adheres to said transparent substrate.

2. The method of claim 1, further comprising etching said patterned material and said transparent substrate to form a negative image of said patterned surface.

3. The method of claim 1, wherein said patterned surface includes a release material, and wherein said transparent substrate includes an adhesion material.

4. The method of claim 1, wherein said conductive substrate is a silicon substrate.

5. The method of claim 1, wherein said transparent substrate is a fused silica substrate.

6. The method of claim 1, wherein said applying energy includes applying thermal energy.

7. The method of claim 1, wherein said applying energy includes applying light energy.

8. A method comprising:
depositing a resist layer on a topographically patterned surface of a silicon substrate;
pressing a substantially planar surface of a substantially transparent substrate and said silicon substrate together, wherein said pressing causes said resist layer to conform to said topographically patterned surface;
hardening said resist layer by applying energy to said material through said substantially transparent substrate, wherein said silicon substrate absorbs a portion of said energy; and
separating said substantially transparent substrate and said silicon substrate, wherein said resist layer adheres to said substantially planar surface of said substantially transparent substrate.

9. The method of claim 8, further comprising removing said resist layer and a portion of said substantially transparent substrate to form a patterned surface in said substantially transparent substrate.

10. The method of claim 8, further comprising applying a non-adhesive material to said topographically patterned surface.

11. The method of claim 8, further comprising applying an adhesive material to said substantially transparent substrate.

12. The method of claim 8, wherein said substantially transparent substrate is a fused silica substrate.

13. The method of claim 8, said applying energy includes applying thermal energy.

14. The method of claim 8, said applying energy includes applying ultra violet light energy.

15. An apparatus comprising:
a topographically patterned surface of a silicon substrate;
a substantially transparent substrate; and
a resist layer disposed between said silicon substrate and said substantially transparent substrate, wherein
said silicon substrate and said substantially transparent substrate are operable to be pressed together,
said substantially transparent substrate is operable to allow energy to pass therethrough, and
said resist layer is operable to adhere to said substantially transparent substrate.

16. The apparatus of claim 15, wherein said substantially transparent substrate is operable to be etched to form a negative image of said topographically patterned surface.

17. The apparatus of claim 15, further comprising a release material disposed on said topographically patterned surface, and an adhesion material disposed on said substantially transparent substrate.

18. The apparatus of claim 15, wherein said substantially transparent substrate is a fused silica substrate.

19. The apparatus of claim 15, wherein said energy is thermal energy.

20. The apparatus of claim 15, wherein said energy is ultra violet light energy.
